(19) United States
(12) Patent Application Publication
(10) Pub. No.: US 2010/0304348 A1
(43) Pub. Date: Dec. 2, 2010

(54) EDUCATIONAL AND TRAINING TOOL USING MATCHING TECHNIQUES AND METHOD OF DEVELOPING AND UTILIZING THE SAME

(76) Inventor: Shlomo Lehavi, Las Vegas, NV (US)

Correspondence Address: GREENBERG TRAURIG (LV), 3773 HOWARD HUGHES PARKWAY, Suite 400 North, LAS VEGAS, NV, 89169, US

(21) Appl. No.: 12/473,013

(22) Filed: May 27, 2009

(51) Int. Cl. G09B 7/00; A63F 9/24

(52) U.S. Cl. 434/322; 463/1

(57) ABSTRACT

A training and education tool in the form of a game. The game is facilitated by software and computer means. A personal computer, including a processor, display and interface device (e.g., mouse, touch screen, haptic device, etc.), is used to implement the education and training tool. A game creation tool allows a user to create a game matrix having game positions filled with text, symbols, colors and/or static or video images. Once the game is created, a game play tool utilizes recognition, association and repetition whereby a player must align two or more matching game matrix positions by switching the position of at least two game matrix positions within the game matrix. Each successful alignment results in an award of points and/or time. Difficulty increases as a player successfully advances through timed game levels.

### FIELD OF THE INVENTION

The embodiments of the present invention relate to an educational tool for use with electronic media utilizing visual matching techniques to educate and train persons regarding any desired subject.

### BACKGROUND

Education is extremely important in today's competitive world. Nonetheless, time spent studying is declining as other day-to-day duties increase in number. One way to keep a person's attention for longer periods of time is to utilize interesting and up-to-date educational tools. For example, online educational tools are popular because they are easy to access and provide user interaction and immediate feedback.

Despite the advances in educational tools, there continues to be a need for an educational tool that is easy to use and capable of teaching any conceivable subject via electronic media. Advantageously, the educational tool should be customizable by a user such that any subject can be taught using the tool.

### SUMMARY

Accordingly, a first embodiment of the present invention is a game development system for developing a game playable via electronic media, comprising: a game creation tool including means for a user to perform one or more of the following: enter a number of game positions to form a game matrix; enter text, symbols, colors and/or static or video images to be displayed within said game positions; enter a number of game levels and associated difficulty; enter a time period for play of each of said game levels; and enter points and/or time awarded for specific game results; means for randomly incorporating the text, symbols, colors and/or static or video images within the game positions; and a game play tool programmed to: permit a player to switch text, symbols, colors and/or static or video images from a first game position with text, symbols, colors and/or static or video images from a second game position in an effort to align two or more like text, symbols, colors and/or static or video images on said game matrix; award points based on the player aligning two or more like text, symbols, colors and/or static or video images within said game matrix; and advance game levels responsive to the player obtaining a threshold number of points during a pre-established time period associated with a subject game level.

Another embodiment of the present invention is a method for developing a game playable on an electronic media, comprising: via a game creation tool allowing a user to perform one or more of the following: entering a number of game positions to form a game matrix; entering text, symbols, colors and/or static or video images to be displayed within said game positions; entering a number of game levels and associated difficulty; entering a time period for play of each of said game levels; and entering points and/or time awarded for specific game results; randomly incorporating the text, symbols, colors and/or static or video images within the game positions; and via a game play tool: permitting a player to switch text, symbols, colors and/or static or video images from a first game position with text, symbols, colors and/or static or video images from a second game position in an effort to align two or more like text, symbols, colors and/or static or video images within said game matrix; awarding points based on the player aligning two or more like text, symbols, colors and/or static or video images on said game matrix; and advancing game levels responsive to the player obtaining a threshold number of points during a pre-established time period associated with a subject game level.

Another embodiment of the present invention is a computer storage medium for developing a game playable via electronic media, comprising: game creation code for allowing a user to perform one or more of the following: entering a number of game positions to form a game matrix; entering text, symbols, colors and/or static or video images to be displayed within said game positions; entering a number of game levels and associated difficulty; entering a time period for play of each of said game levels; and entering points and/or time awarded for specific game results; code for randomly incorporating the text, symbols, colors and/or static or video images within the game positions; and game play code for: permitting a player to switch text, symbols, colors and/or static or video images from a first game position with text, symbols, colors and/or static or video images from a second game position in an effort to align two or more like text, symbols, colors and/or static or video images within said game matrix; awarding points based on the player aligning two or more like text, symbols, colors and/or static or video images on said game matrix; and advancing game levels responsive to the player obtaining a threshold number of points during a pre-established time period associated with a subject game level.

Another embodiment of the present invention is an educational tool for use with an electronic media comprising: a game matrix including a plurality of game positions wherein each game position includes text, colors, symbols and/or static or video images associated with a specific educational topic; a game play tool configured to: permit a player to switch a first game position with a second game position in an effort to align two or more like text, symbols, colors and/or static or video images within said game matrix; award points and/or time based on the player aligning two or more like text, symbols, colors and/or static or video images within said game matrix; remove and replace game positions which are aligned and result in an award of points and/or time; and advance game levels responsive to the player obtaining a threshold number of points during a pre-established time period associated with a subject game level, each subsequent game level increasing in difficulty.

The embodiments of the present invention allow users to match same text, symbols, colors and/or images, including static photos and video, in a simulated game matrix. The repetitive matching of identical or related game matrix positions assimilating and assisting and leading to memorization. Points are awarded based on a number of correct matches and the time needed for such matches to occur. Moreover, other features including pop-up quiz questions related to the subject being taught by the text, symbols, colors and/or static and video images may be presented to the user as further means for teaching, not just visual matching.

Other variations, embodiments and features of the present invention will become evident from the following detailed description, drawings and claims.

### BRIEF DESCRIPTION OF THE DRAWINGS

FIGS. 1-15 illustrate screen shots of a game creation tool or “wizard” for developing a game according to the embodiments of the present invention;

FIGS. 16-23 illustrate screen shots of the game matrix and various related screens; and

FIG. 24 illustrates a flow chart detailing one method of conducting a game as an educational tool according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention relate to training and education in the form of a game presented via an electronic media. While the embodiments may be used relative to any field, the detailed disclosure herein focuses on the dental field. It will be recognized by those skilled in the art that the embodiments of the present invention may be used to teach any subject matter. Moreover, the embodiments of the present invention involve a game matrix premised on matching and aligning identical or related game matrix positions.

The embodiments of the present invention are facilitated by software and computer means. A software-based engine (i.e., software program) drives the systems and methods disclosed herein. In one embodiment, a personal computer, including a processor, display and interface device (e.g., mouse, touch screen, haptic device, etc.), is used to implement the education and training tools of the present invention. The embodiments of the present invention may also be facilitated by a hand-held device (e.g., cellular telephone, PDA, iphone, etc.) or online network (e.g., the Internet). In one embodiment, the educational tool/game is accessed via a dedicated website.

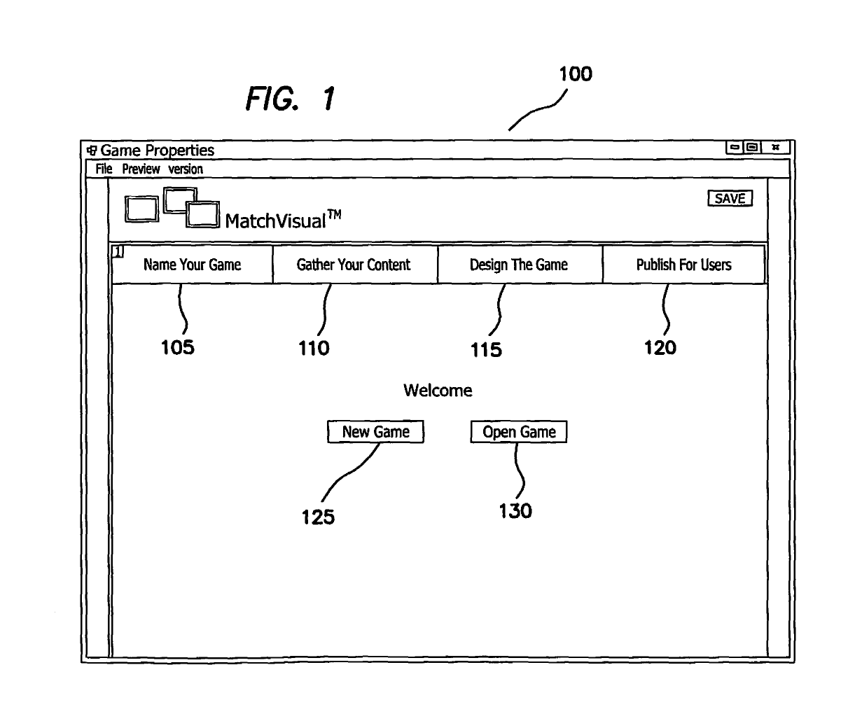

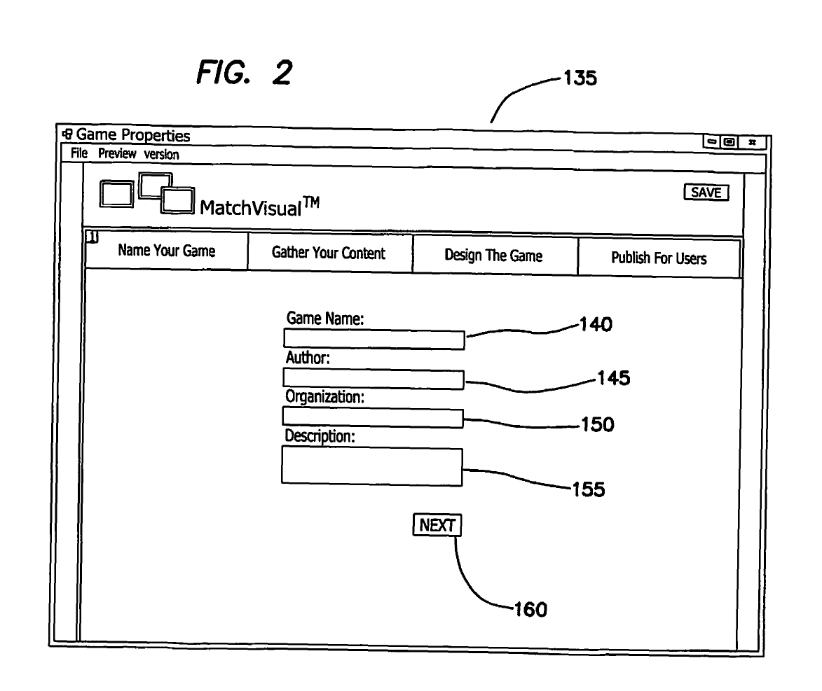

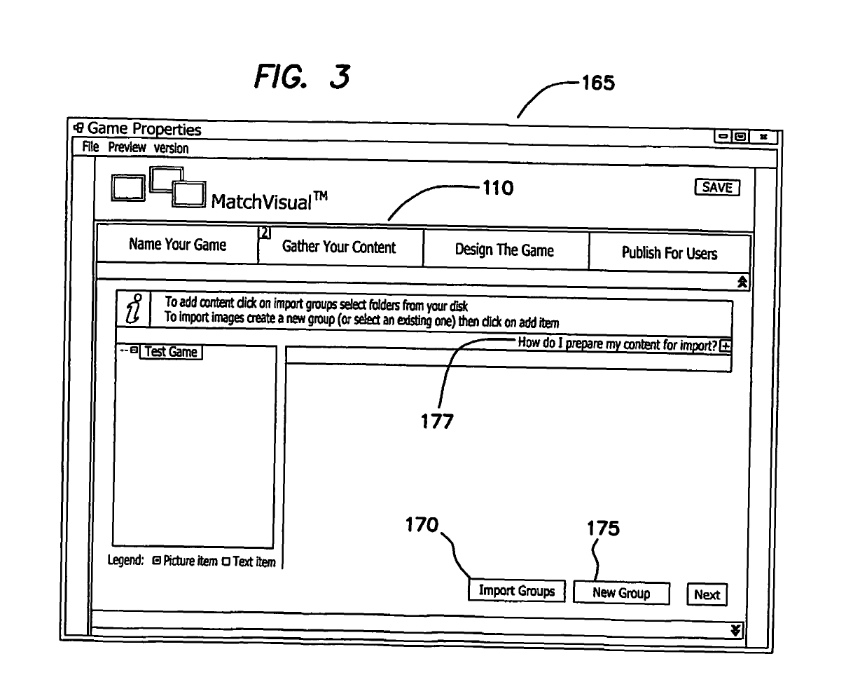

FIGS. 1-15 show exemplary screen shots depicting a development tool or “wizard” which allows a user to develop a game according to the embodiments. Initial screen shot 100, illustrated in FIG. 1, shows four development stage tabs including Name Your Game tab 105, Gather Your Content tab 110, Design The Game tab 115 and Publish For Users tab 120. The four development stage tabs define a game creation tool. Screen 100 shows the Name Your Game tab 105 highlighted while the screen 100 allows a user to choose between a New Game icon 125 or Open Game icon 130. If the user selects the Open Game icon 130, the user is directed to the development stages for an already created game (complete or partial). If the user selects the New Game icon 125, the user is directed to screen 135, illustrated in FIG. 2, depicting text boxes for entry of Game Name 140, Author 145, Organization 150 and Description 155. After clicking on the Next icon 160, the user is directed to screen 165, illustrated in FIG. 3.

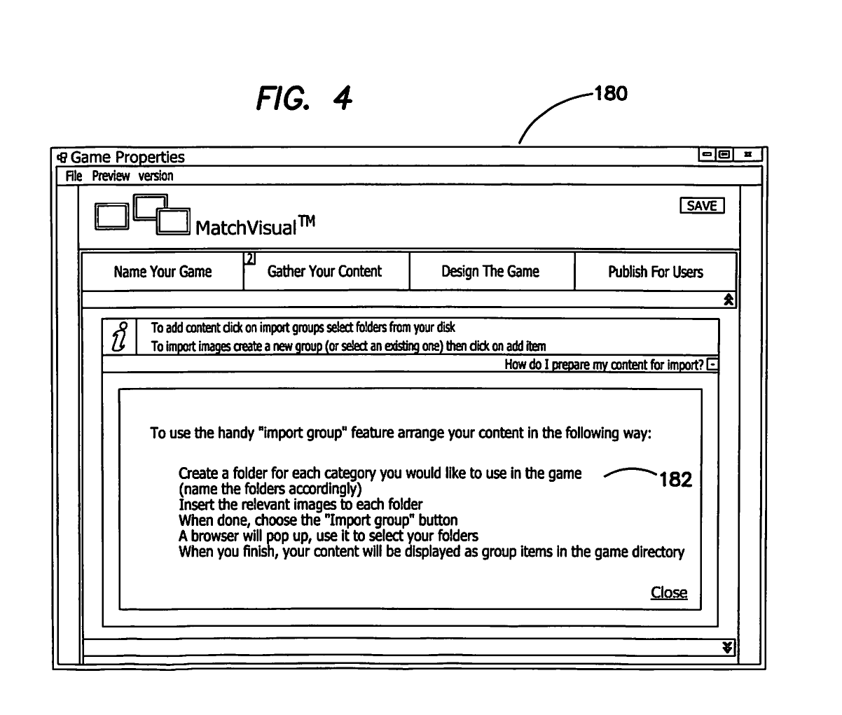

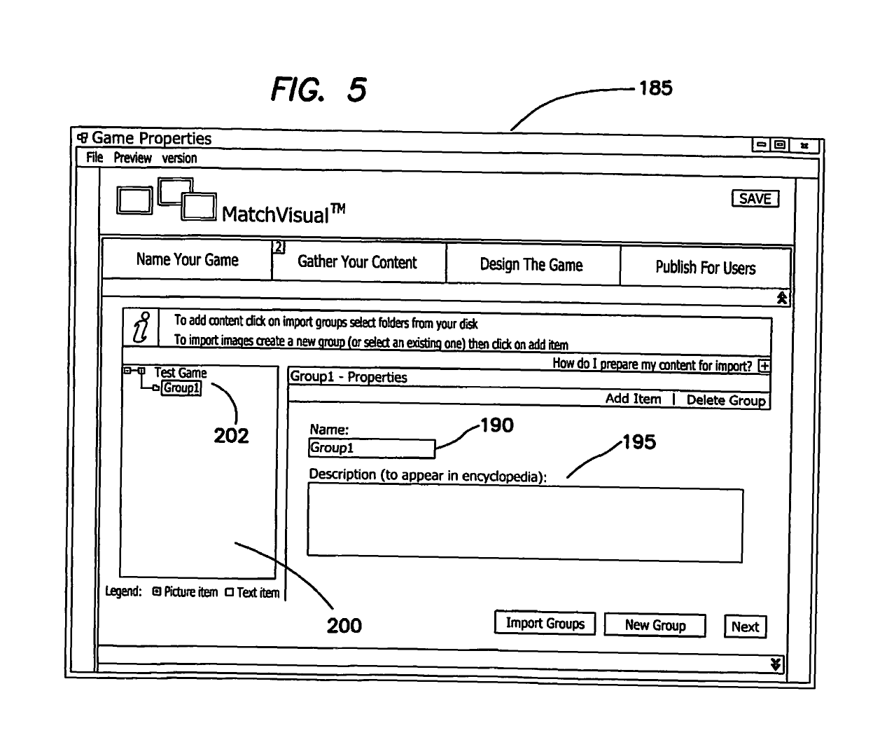

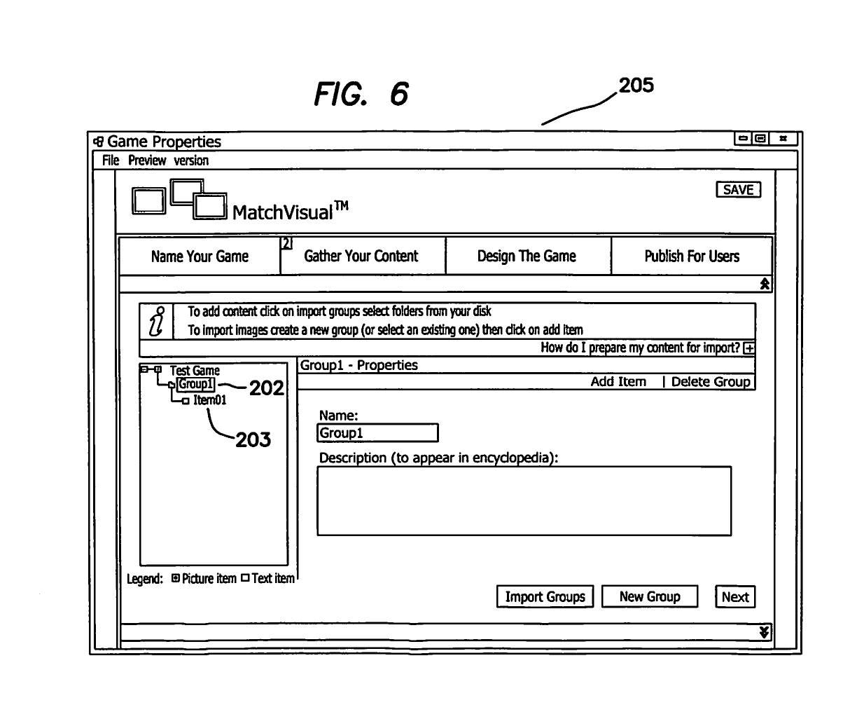

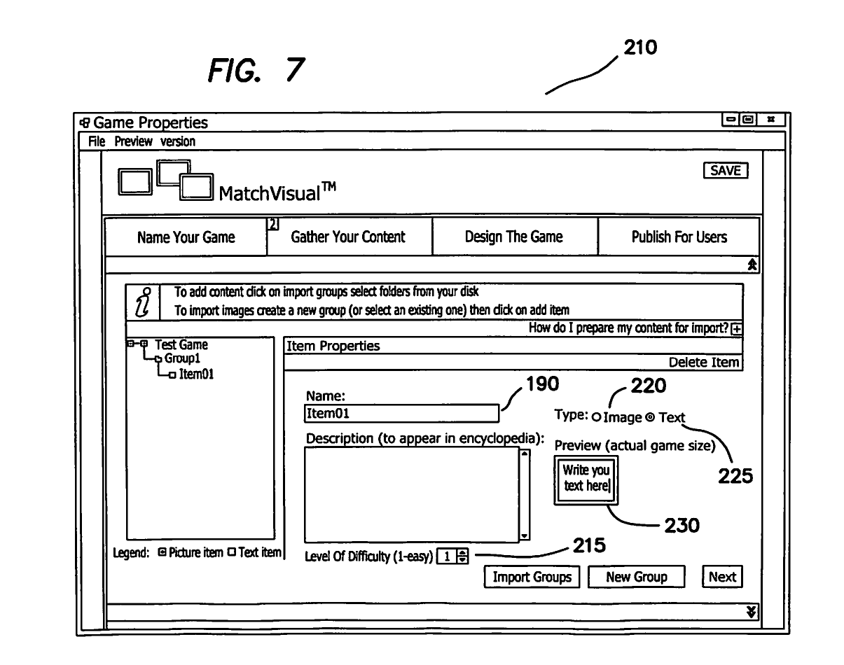

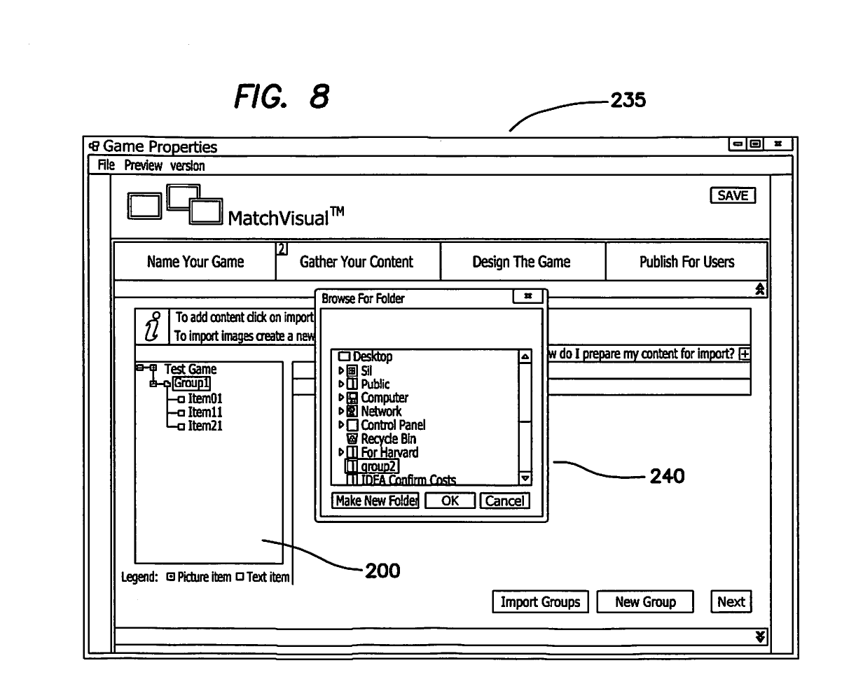

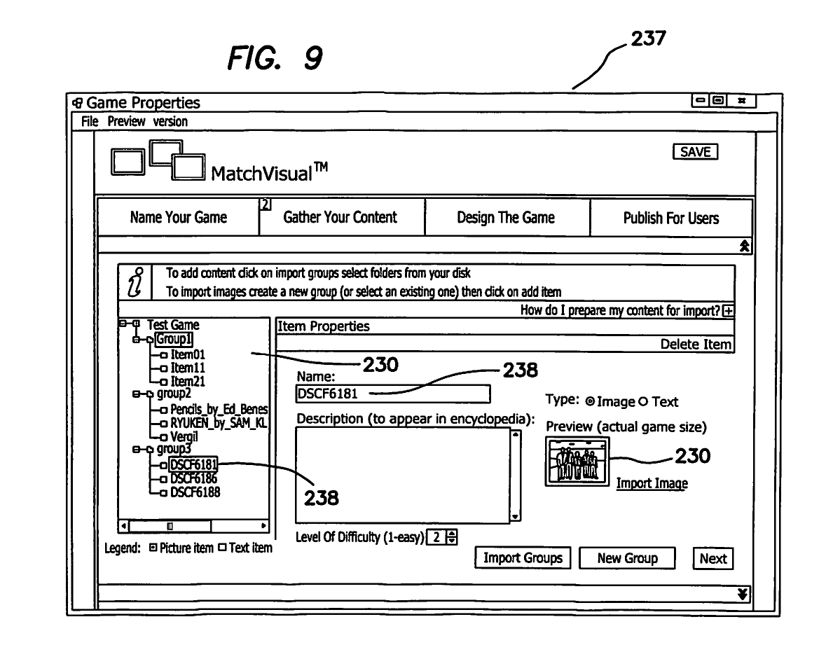

Screen 165 shows the Gather Your Content tab 110 highlighted while the screen 110 allows a user to either import images from a storage location (e.g., disk, hard drive, etc.) using the Import Groups icon 170 or create New Group icon 175. Screen 180, illustrated in FIG. 4, shows an instruction tool 182, opened responsive to clicking on “How do I prepare my content for import?” 177, providing instructions regarding the Import Group icon 170. Screen 185, illustrated in FIG. 5, depicts a text box for entry of a Name 190, Group I as shown, and Description 195. Also, depicted is a file section 200 identifying a Test Game file with a Group I folder 202 linked thereto. Screen 205, illustrated in FIG. 6, shows the Group I folder 202 highlighted with a Item 01 folder 203 linked thereto. Screen 210, illustrated in FIG. 7, shows Item 01 203 listed in the Name text box 190. The screen 210 also depicts a Level of Difficulty setting 215, Type image option 220, Type text option 225 and preview box 230 opened responsive to the Type text option being selected. At this stage, the user may use the text box 230 to create text for inclusion in the game positions of the game matrix. As shown, the preview box 230 is an actual size of the game matrix positions so that the user may preview the text in relation to the complete game matrix. Screen 235, illustrated in FIG. 8, shows a folder browser 240 open allowing a user to select additional content for inclusion in the file section 200. Screen 237, illustrated in FIG. 9, shows the file section 200 populated with three groups of content. A file name (DSCF6181) identifies a photo/image as shown in the preview box 230.

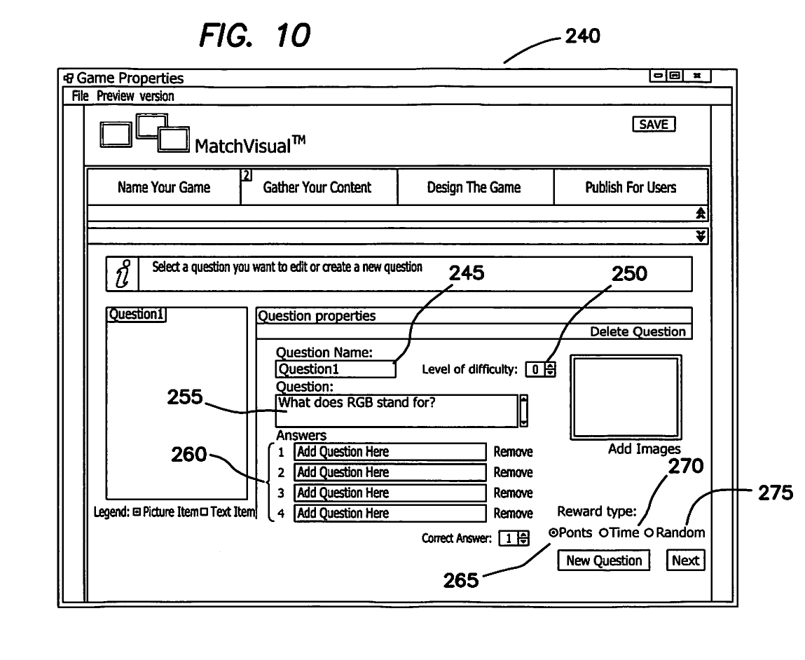

Screen 240, illustrated in FIG. 10, shows a question generating scheme. Question name text box 245, level of difficulty 250, question box 255 and answer boxes 260 are shown. There are also reward type designations, namely points 265, time 270 and random 275. The questions will be used during stages of the game as prescribed by the user via the reward type designations and further described below.

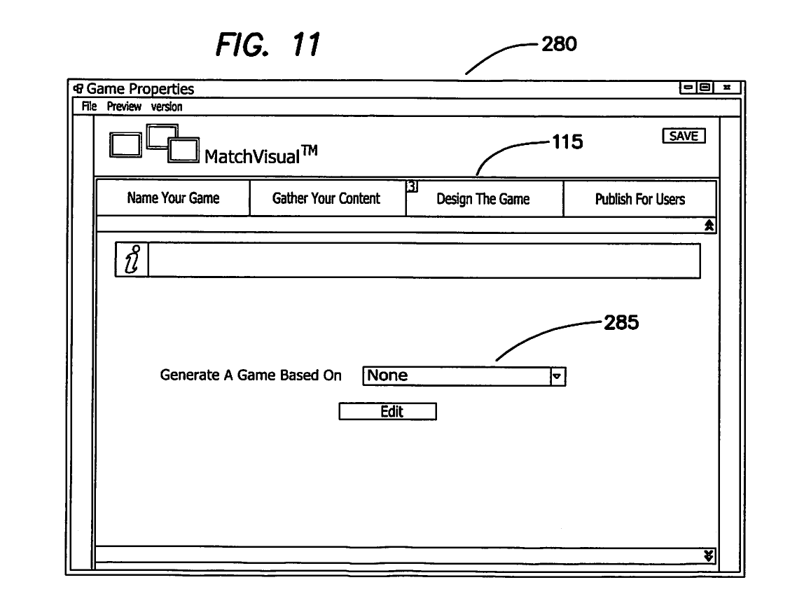

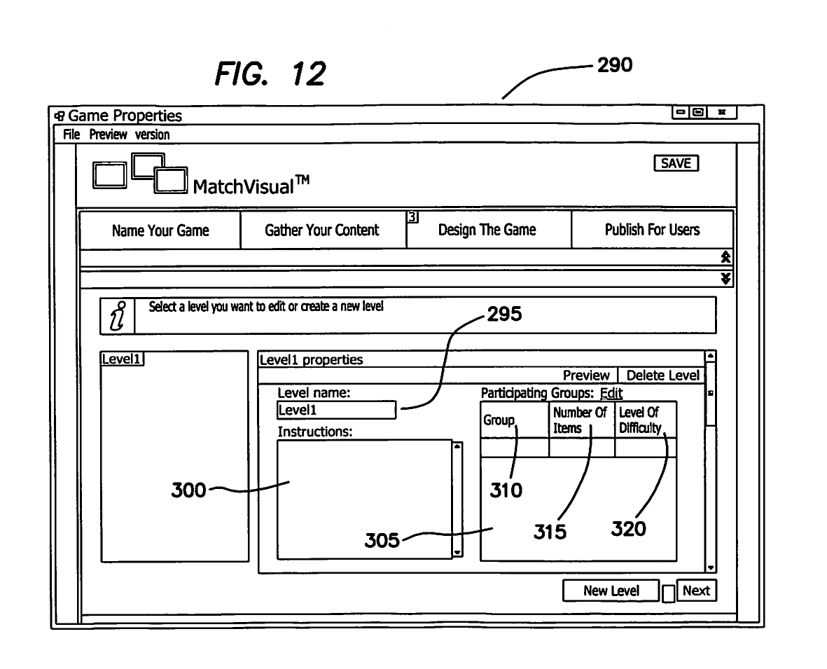

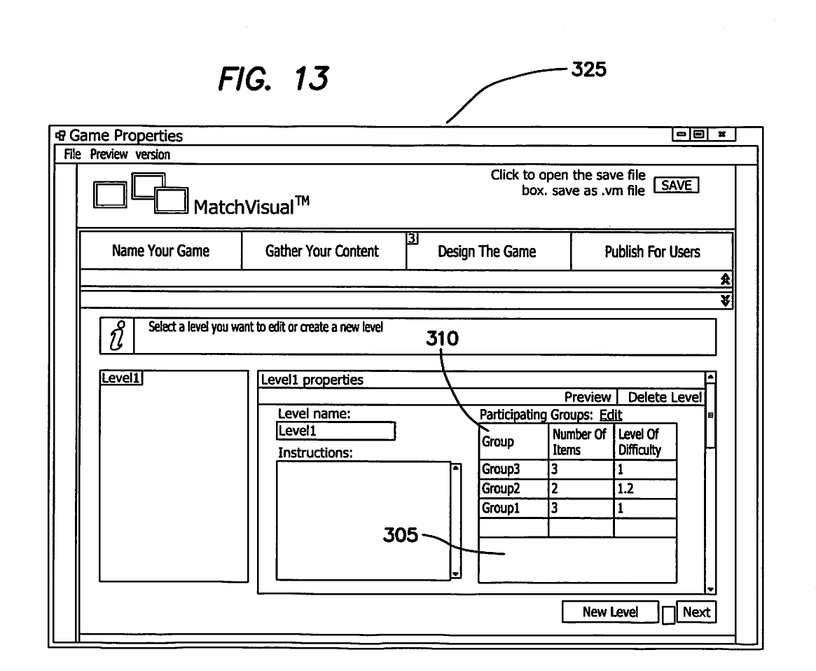

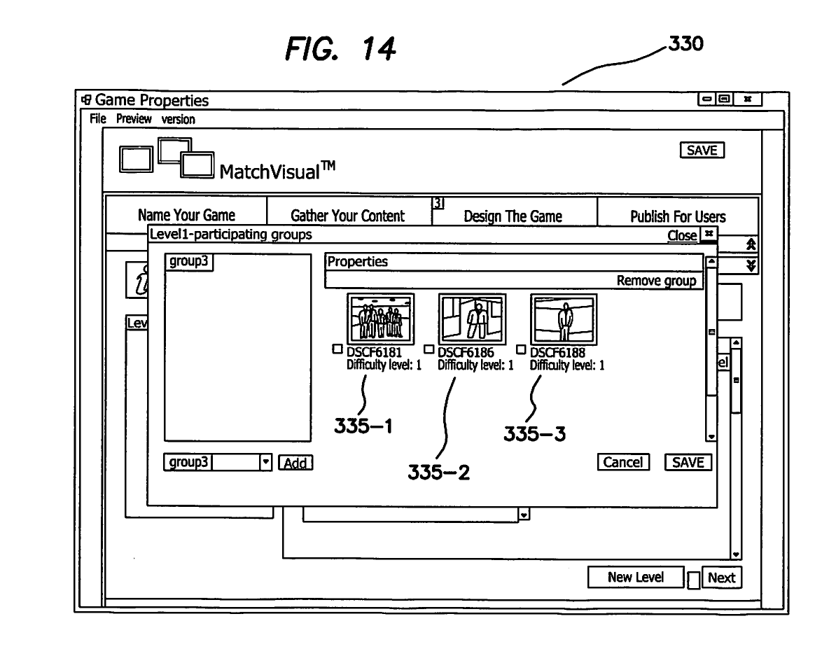

Screen 280, illustrated in FIG. 11, shows the Design the Game tab 115 highlighted. Initially, a Generate a Game Based On drop down menu 285 is used to begin the design of the game. Screen 290, illustrated in FIG. 12, shows a Level Name text box 295 (Level 1 as shown), Instructions text box 300 and Participating Groups section 305, namely group headers. The Participating Group Section 305 includes a Group header 310, Number of Items header 315 and Level of Difficulty header 320. Screen 325, illustrated in FIG. 13, shows the Participating Groups section 305 populated with Groups 1, 2, and 3. Screen 330, illustrated in FIG. 14, shows Group 3 highlighted and containing three photos/images 335-1 through 335-3.

The screens described above are used to create a game matrix and game rules as described in more detail below. Those skilled in the art will recognize that the screens described above and shown in the figures are exemplary and can be designed, configured or arranged in any number of ways without departing from the spirit and scope of the present invention.

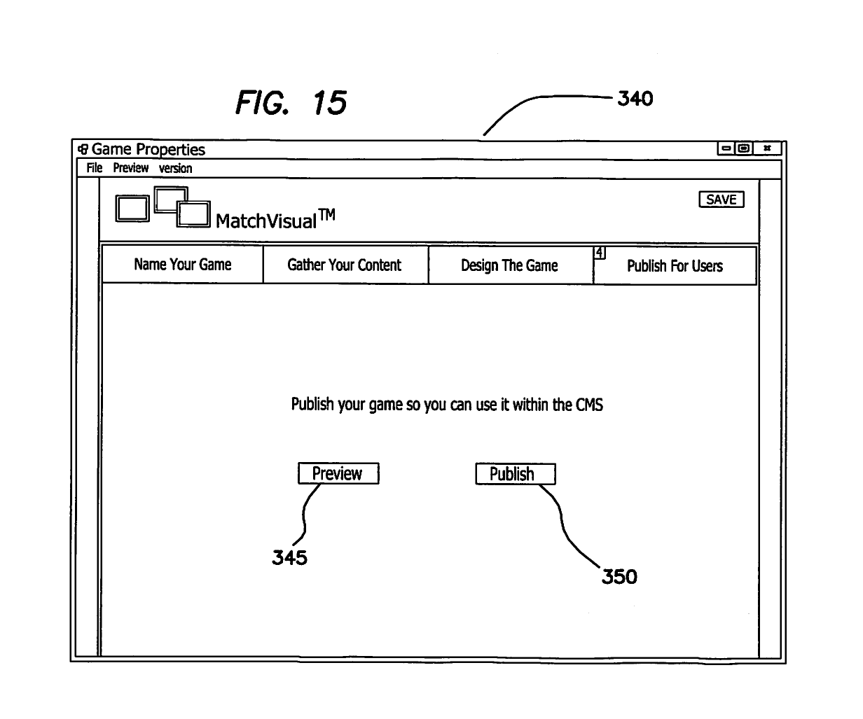

Screen 340, illustrated in FIG. 15, shows Publish For Users tab 120 highlighted. Preview link 345 and Publish link 350 permit the user to preview the game or publish the game, respectively, as described below.

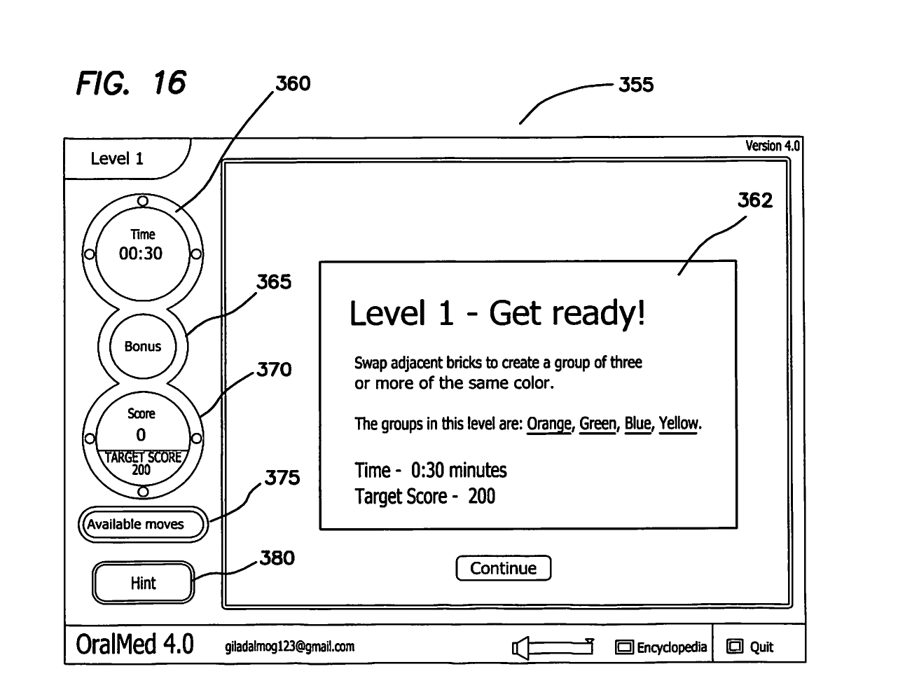

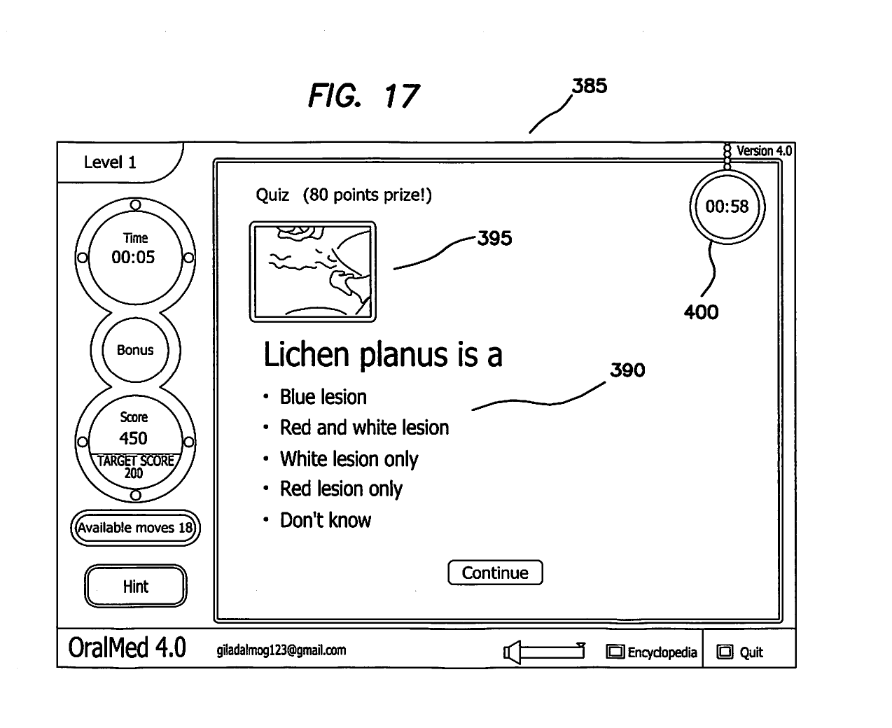

FIGS. 16-23 illustrate screen shots depicting a game matrix and related screens which may be encountered during play of the educational tool/game. A game play tool utilizes the information collected by the game creation tool to facilitate play of the game. Screen 355, shown in FIG. 16, is associated with Level 1 of a new game. An instruction window 362 provides the player with information including instructions, groups involved, time and target score. A left side of the screen 355 depicts a clock 360, bonus window 365, score window 370, available moves window 375 and hint link 380. The available moves window 375 provides a user with a running number of possible moves available on the screen while the hint link 380 highlights the user with an actual move that can be made. Screen 385, shown in FIG. 17, depicts an exemplary quiz question 390 of the type that may be encountered during play of the educational tool/game. The quiz question 390 relates to the dental field and may be posted with a reference photo/image 395 as well. In this instance, the quiz question 390 is multiple choice but the quiz questions may also be true and false or require a player to enter an answer with no choices provided. Answers to the quiz questions generate points and/or extra time. In this instance, 80 points is awarded for the correct answer. Wrong answers may result in no points or negative points. A quiz question clock 400 tracks time available for the player to answer the quiz question 390.

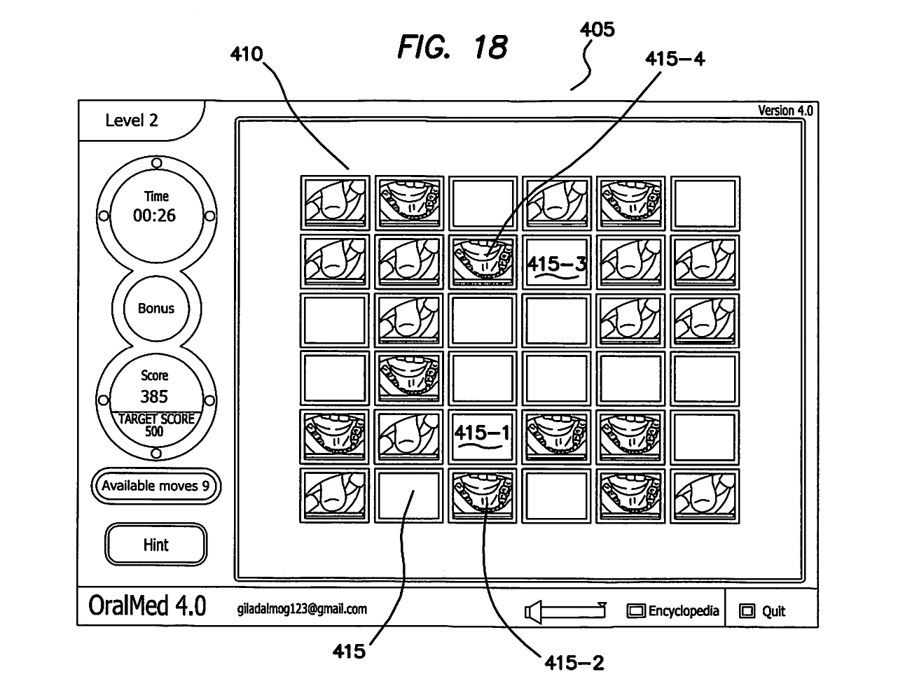

Screen 405, shown in FIG. 18, illustrates a game matrix 410 comprising 36 game positions 415. The game positions are filled with text, symbols, colors, images and/or video content in a random manner as facilitated by a software module developed for the same. Randomizing programs are known in the art and need not be disclosed herein. In this embodiment, each game position 415 contains a color or image. The object of the game is to arrange, adjacent to one another, two or more matching colors or images contained within game positions 415. In one embodiment, as described herein, three matching colors or images are required. The three matching colors or images may be vertically aligned, horizontally aligned and/or diagonally aligned. In one embodiment, moving colors or images is accomplished by clicking on a first game position and then a second adjacent game position which causes the two adjacent game positions to switch positions. Alternatively, any two game positions, whether adjacent or not, may be switched with one another. Responsive to three matching colors or images being aligned, points and/or time are awarded and the three matching colors or images are removed and randomly replaced with replacement colors and images. For example, clicking on game position 415-1 and then adjacent game position 415-2 causes the two adjacent game positions to switch resulting in three horizontally aligned matching images. Clicking on the game positions may be accomplished using a mouse, touch screen, key strokes or as discussed below, a haptic device. The haptic device allows a user to slide matrix positions rather than clicking on matrix positions via a mouse. Consequently, points and/or time are awarded and the three horizontally aligned matching photos are removed and replaced with replacement colors and/or images. In one embodiment, the three removed images are replaced without any impact on the rest of the game matrix positions 415. In another embodiment, the three removed images are filled in by lowering all game positions thereabove and adding new colors and/or images within the uppermost row. In another example, clicking on game position 415-3 and game position 415-4 causes the two adjacent game positions to switch resulting in three vertically aligned game positions containing matching orange colors.

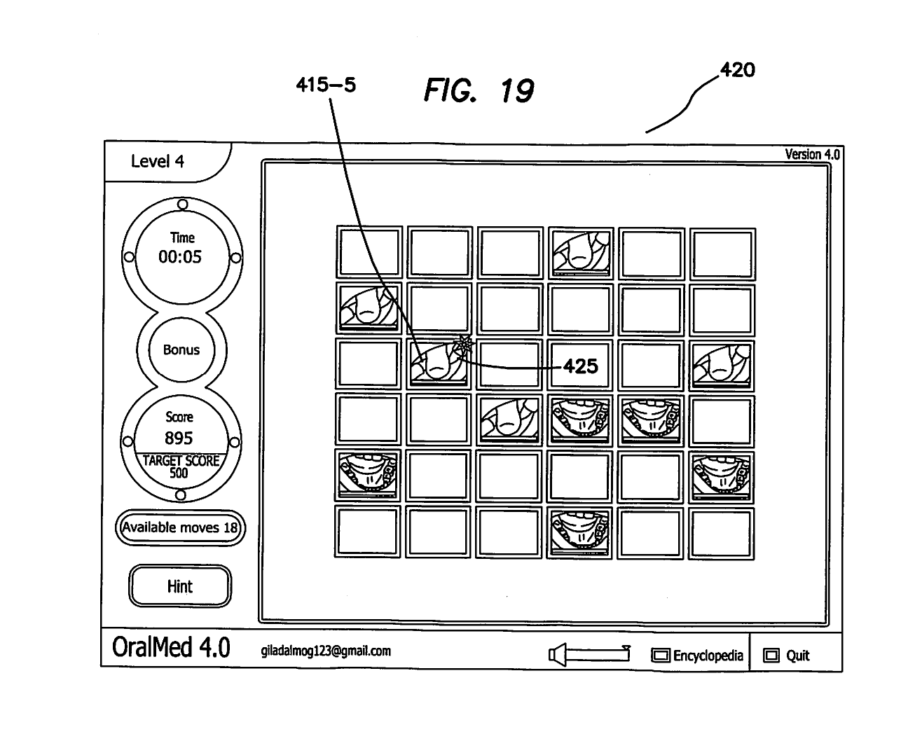

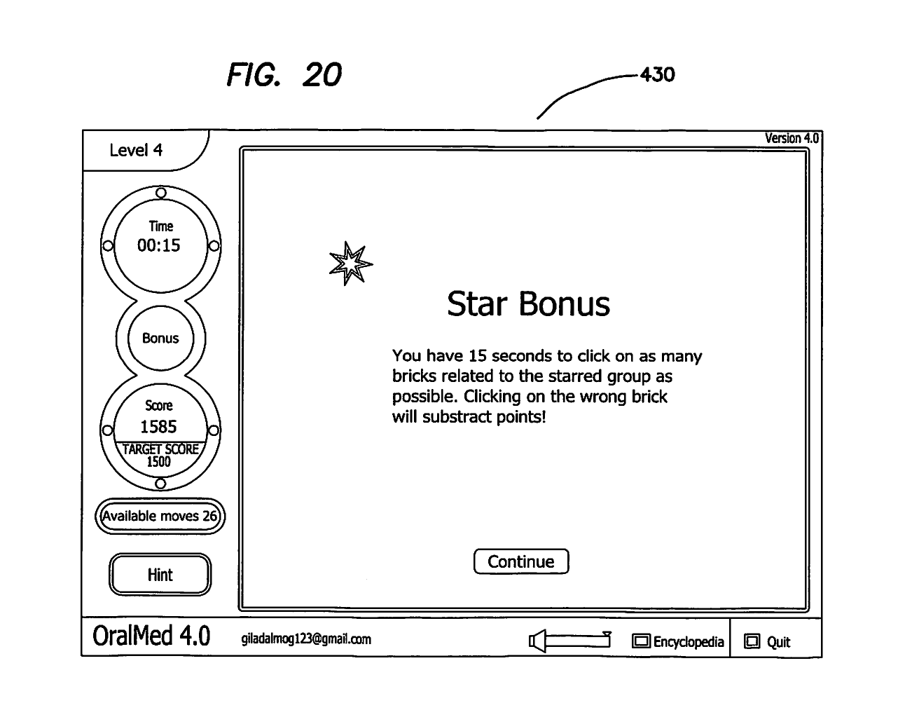

Screen 420, as illustrated in FIG. 19, shows the game matrix with a star bonus 425 in place on game position 415-5. While a star symbolizes the bonus, any mark, may symbolize the bonus. Indeed, game positions corresponding to bonus rounds may be identified in a concealed manner such that the triggering or activation of a bonus round is a surprise to the player. Should the player use the game position 415-5 with the associated star bonus 425 to align three matching game positions, the player is afforded a bonus round. Screen 430, as illustrated in FIG. 20, details the bonus round. The bonus round comprises the player being given a pre-established time period (e.g., 15 seconds a shown in FIG. 20) to click on (or slide using a haptic device) all related matrix positions to the matched game positions on the screen. The player is awarded points based on the number of correct matrix positions identified by the player in the given time period. If the player identifies each and every related matrix position on the screen, an enhanced bonus award may be provided. Those skilled in the art will recognize that the bonus round as detailed is exemplary only and may be crafted in any number of ways.

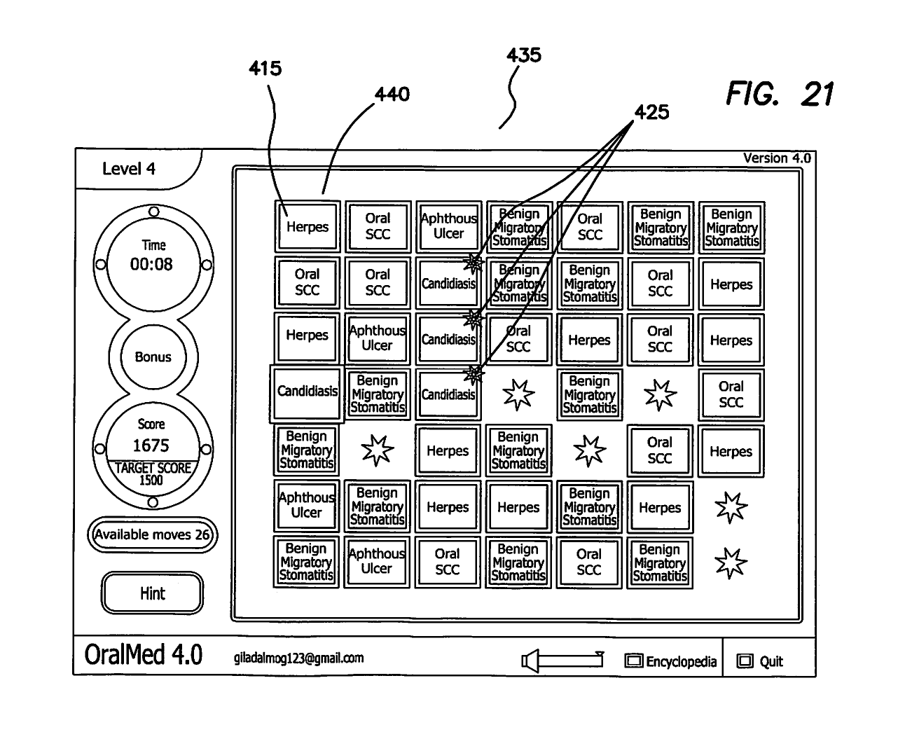

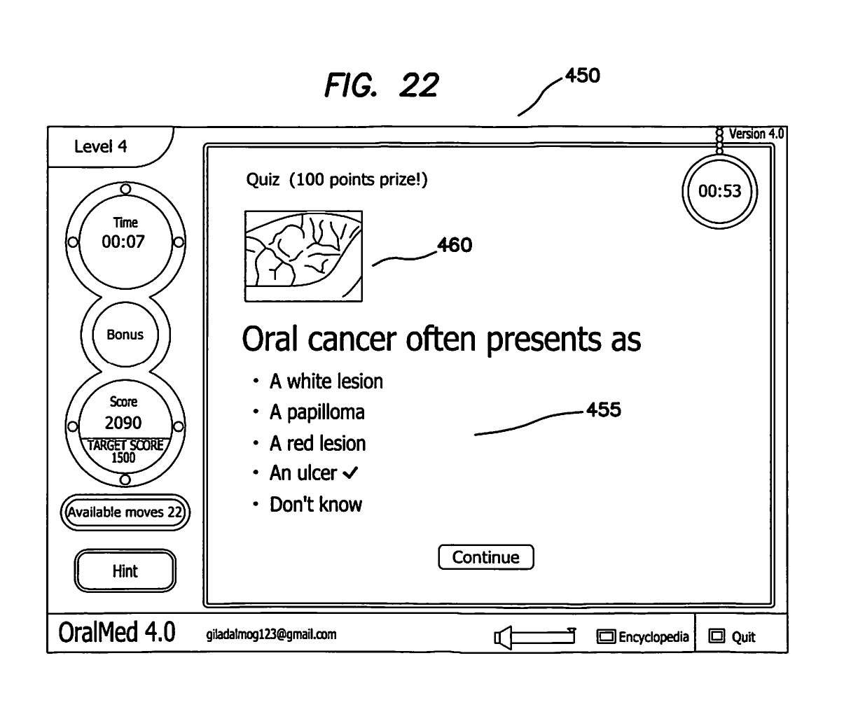

Screen 435, as illustrated in FIG. 21, shows a game matrix 440 comprising 49 game positions 415. In this embodiment, the game positions 415 contain text and colors. The same objective is associated with this embodiment of the present invention as set forth above. However, in some cases, responsive to three matching game positions being aligned, one or more game positions 415 are removed and not replaced. Screen 450, as illustrated in FIG. 22, shows another exemplary multiple choice quiz question 455 and image 460.

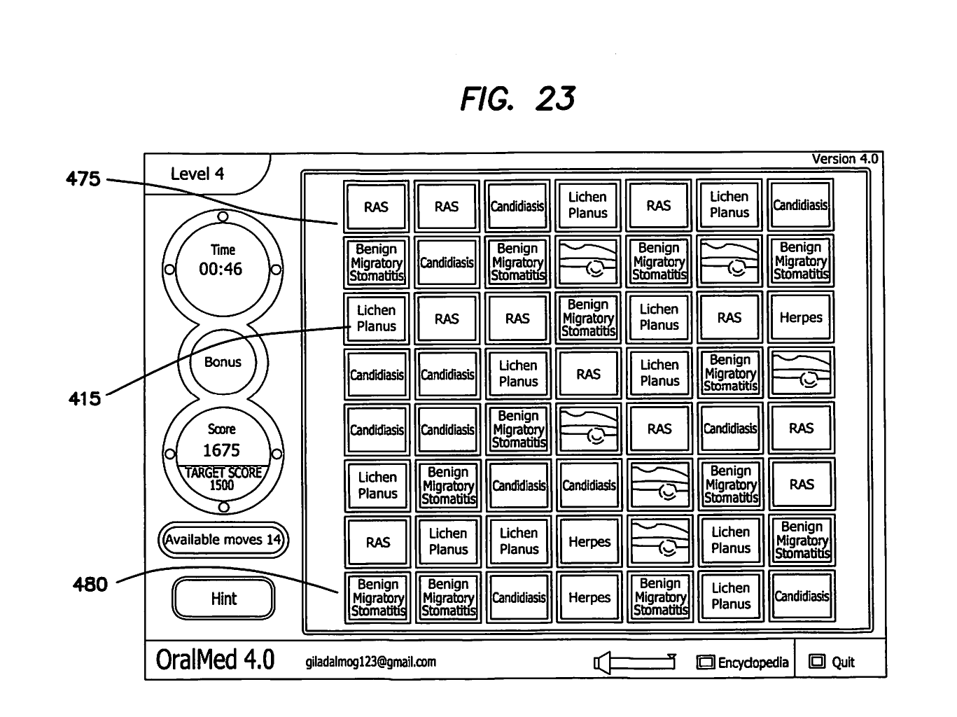

Screen 475, as illustrated in FIG. 23, shows a game matrix 480 comprising 56 game positions 415. In this embodiment, the game positions 415 contain text, symbols, colors and/or static and vido images. In this embodiment, a player may align three matching game positions having text corresponding to the images. For example, two game positions reciting “Herpes” may be aligned with an image depicting herpes thereby creating a winning alignment combination.

In one embodiment of the present invention, each upward level has an increased difficulty as set by the individual creating the game. The difficulty may be based on more closely related photos of dental diseases such that it is more difficult to distinguish between them and thus match and align them accordingly. Alternatively or additionally, the time period allotted for completion of the game levels decreases as a player advances game levels. Difficulty is also dictated by the number of possible moves as determined by the number of families or topics and the number of children or related topic types.

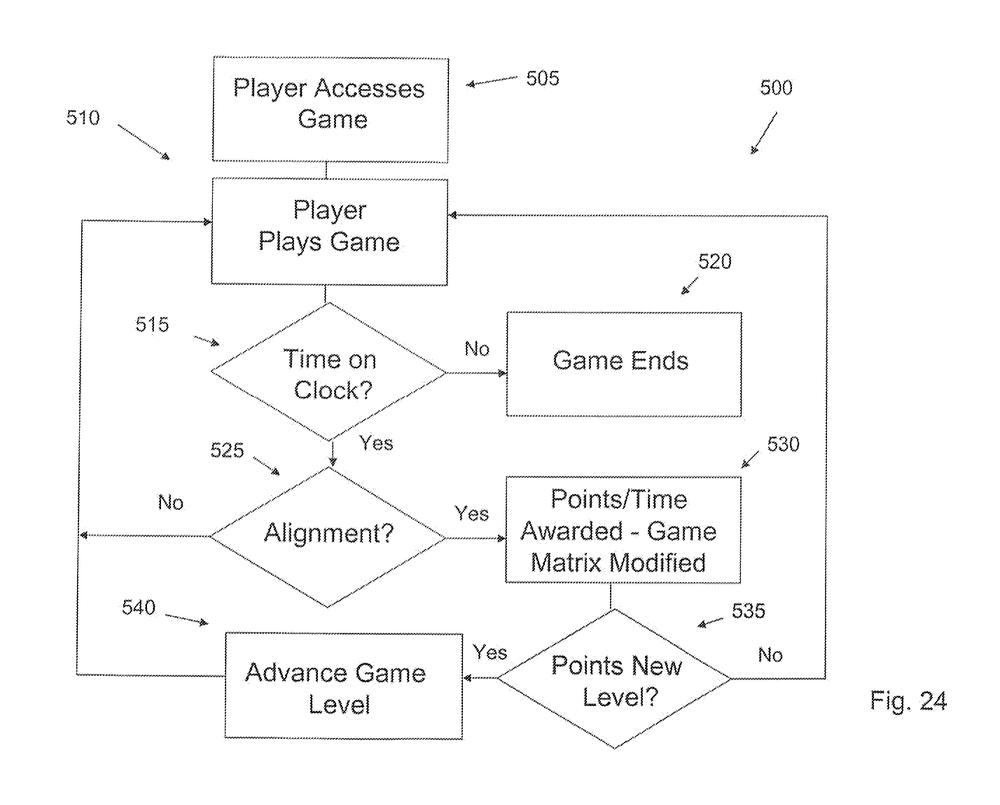

FIG. 24 illustrates a flow chart 500 detailing one method of playing a game according to the embodiments of the present invention. At 505, a player accesses the game. Access may be accomplished by signing into a dedicated website, accessing a free website, accessing a local area network, downloading software onto a computer, or in any other manner suitable to access and play electronic media games. At 510, the player begins play at level one wherein the player seeks to arrange, adjacent to one another (i.e., vertically, horizontally and/or diagonally), three matching text, symbols, colors and/or static and video images contained within the game positions. At 515, it is determined whether any time was on the clock when the game position switch occurred. If not, at 520, the game ends. If so, at 525, it is determined whether the preceding move by the player results in three aligned matching text, symbols, colors and/or static and video images. If so, at 530, points and/or time are awarded and the three aligned matching text, symbols, colors and/or static and video images are removed and replaced with new text, symbols, colors and/or static and video images. At 535 it is determined whether enough points have been obtained to advance to a next game level. If so, at 540 the game advances to the next level and the chart loops to 510 for continued play. If not, the chart loops to 510 for continued game play within the same game level. If it is determined that there is no winning alignment at 525, the chart loops to 510 for continued game play at the same game level. While not detailed in the flow chart, quiz questions may be randomly presented to the player during play. Alternatively, the quiz questions are presented responsive to a point total, certain game positions being moved, etc. Also, certain game positions may be marked with the star bonus 430 such the inclusion of the corresponding game position in a winning combination advances the player to a bonus round. The quiz questions and bonus round are intended to provide players additional opportunities to amass points such the player may advance to the next game level. The quiz questions also provide an additional teaching opportunity by testing the players knowledge.

The embodiments of the present invention have many benefits, including use as 1) a game development system; 2) educational tool and 3) social networking mechanism.

As a game development tool, the game creation tool or “wizard” allows for the easy creation of a game including time allotments, questions, penalties, points and use of text, symbols, colors and/or static and video images. In one embodiment, games are recorded for later playback to teach and critique a player.

As an educational tool, the game relies on recognition, association and repetition to teach a player a desired subject (e.g., dental terms and disease related to oral medicine and pathology as shown herein). Also, the use of text and corresponding images, including static photos and video, teaches players the associate the disease term with the appearance of the disease in practice. The use of the quiz questions also provides a testing tool for the player providing immediate feedback. In a dental version, the game is ideal as a teaching tool for dental school professors and students. Dental professionals can also benefit from the game. In addition, the game creation tool facilitates teaching.

In practice, as described above, the created games can be shared (i.e., published) with others (e.g., online or via a dedicated website). Such a sharing builds meaningful relationships which facilitate teaching as opposed to conventional social networking sites which may foster online friendships but fail to develop anyone's intelligence. In one embodiment, licensed members are able to access many different published games on a dedicated website. In another embodiment, a dental school professor may limit access to his or her games via a password protected website. Despite the mechanism for making the games available to those interested, those skilled in the art will recognize that the game is educational in nature and may be based on any desired subject matter.

There are several different publication vehicles envisioned with respect to the developed game. The game may be published to a specific group of people (e.g., class of students) having authority to access the game or more widely to anyone accessing a dedicated website for example. In one embodiment, when the game is developed and/or published on a dedicated website, encryption keys or code are integrated into the game. The program running the game subsequently confirms the encryption keys or code prior to activating the game to make sure access is provided only to those individuals accessing the game via the dedicated website.

In another embodiment of the present invention, a haptic device, like the type manufactured by Sensable of Woburn, Mass., is linked to the computer terminal or hand-held device or other electronic media used to play of the game. A haptic device makes it possible for a player to touch and manipulate virtual objects while receiving feedback associated therewith. Haptic devices have been used to practice dental techniques (e.g., drilling) on virtual teeth displayed on a monitor or screen. As used herein, the haptic device is used by the player (e.g., dental student or dentist) to arrange the game positions providing the player with experience using the haptic device in anticipation of using the same device for more complex and detailed procedures associated with dental procedures on virtual teeth.

Although the invention has been described in detail with reference to several embodiments, additional variations and modifications exist within the scope and spirit of the invention as described and defined in the following claims.

1. A game development system for developing a game playable via electronic media, comprising:
a game creation tool including means for a user to perform one or more of the following:
enter a number of game positions to form a game matrix;
enter text, symbols, colors, and/or static or video images to be displayed within said game positions;
enter a number of game levels and associated difficulty;
enter number of topics and topic types;
enter a time period for play of each of said game levels; and
enter points and/or time awarded for specific game results;
means for device for randomly incorporating the text, symbols, colors and/or static or video images in the game positions; and
a game play tool programmed to:
permit a player to switch text, symbols, colors and/or static or video images from a first game position with text, symbols, colors and/or static or video images from a second game position in an effort to align two or more like text, symbols, colors and/or static or video images within said game matrix;
award points and/or time based on the player aligning two or more like text, symbols, colors and/or static or video images within said game matrix; and
advance game levels responsive to the player obtaining a threshold number of points during a pre-established time period associated with a subject game level.

2. The system of claim 1 wherein said game creation tool further includes means to generate quiz questions.

3. The system of claim 2 wherein said game play tool is further programmed to display one of said quiz questions responsive to pre-established game criteria.

4. The system of claim 3 wherein said pre-established game criteria is selected from the group consisting of total number of points, use of pre-established game positions and level time.

5. The system of claim 1 wherein said game creation tool further includes means to integrate a bonus activated with an alignment of one or more pre-established game positions.

6. The system of claim 1 wherein said game play tool is configured to communicate with a haptic device such that said haptic device permits a player to switch text, symbols, colors and/or static or video images from a first game position with text, symbols, colors and/or static or video images from a second game position in an effort to align two or more like text, symbols, colors and/or static or video images within said game matrix.

7. A method for developing a game playable on an electronic media, comprising:
via a game creation tool allowing a user to perform one or more of the following:
entering a number of game positions to form a game matrix;
entering text, symbols, colors and/or static or video images to be displayed within said game positions;
enter number of topics and topic types;
entering a number of game levels and associated difficulty;
entering a time period for play of each of said game levels; and
entering points and/or time awarded for specific game results;
randomly incorporating the text, symbols, colors and/or static or video images within the game positions; and
via a game play tool:
permitting a player to switch text, symbols, colors and/or static or video images from a first game position with text, symbols, colors and/or static or video images from a second game position in an effort to align two or more like text, symbols, colors and/or static or video images within said game matrix;
awarding points and/or time based on the player aligning or more like text, symbols, colors and/or static or video images on said game matrix; and
advancing game levels responsive to the player obtaining a threshold number of points during a pre-established time period associated with a subject game level.

8. The method of claim 7 further comprising, via said game creation tool, generating quiz questions.

9. The method of claim 7 further comprising, via said game play tool, displaying one of said quiz questions responsive to pre-established game criteria.

10. The method of claim 9 further comprising establishing said pre-established game criteria as one or more of the following: total number of points, use of pre-established game positions and level time.

11. The method of claim 7 further comprising, via said game creation tool, integrating a bonus associated with alignment of one or more pre-established game positions.

12. The method of claim 7 further comprising configuring the game play tool to communicate with a haptic device whereby a player may use the haptic device to switch text, symbols, colors and/or static or video images from a first game position with text, symbols, colors and/or static or video images from a second game position in an effort to align two or more like text, symbols, colors and/or static or video images within said game matrix

13. A computer storage medium for developing a game playable via electronic media, comprising:
game creation code facilitating a user performing one or more of the following:
entering a number of game positions to form a game matrix;
entering text, symbols, colors and/or static or video images to be displayed within said game positions;
entering a number of topics and topic types;
entering a number of game levels and associated difficulty;
entering a time period for play of each of said game levels; and
entering points and/or time awarded for specific game results;
code for randomly incorporating the text, symbols, colors and/or static or video images within the game positions; and
game play code for:
permitting a player to switch text, symbols, colors and/or static or video images from a first game position with text, symbols, colors and/or static or video images from a second game position in an effort to align two or more like text, symbols, colors and/or static or video images within said game matrix;
awarding points and/or time based on the player aligning two or more like text, symbols, colors and/or static or video images on said game matrix; and
advancing game levels responsive to the player obtaining a threshold number of points during a pre-established time period associated with a subject game level.

14. The computer storage medium of claim 13 further comprising game creation code for facilitating a user generating quiz questions.

15. The computer storage medium of claim 14 further comprising game play code for displaying one of said quiz questions responsive to pre-established game criteria.

16. The computer storage medium of claim 15 wherein said pre-established game criteria is selected from the group consisting of total number of points, use of pre-established game positions and level time.

17. The computer storage medium of claim 13 further comprising game creation code facilitating a user integrating a bonus associated with alignment of one or more pre-established game positions.

18. An educational tool for use with an electronic media comprising:
a game matrix including a plurality of game positions wherein each game position includes text, colors, symbols and/or static or video images associated with a specific educational topic;
a game play tool configured to:
permit a player to switch a first game position with a second game position in an effort to align two or more like text, symbols, colors and/or static or video images within said game matrix;
award points and/or time based on the player aligning two or more like text, symbols, colors and/or static or video images within said game matrix;
remove and replace game positions which are aligned and result in an award of points and/or time; and
advance game levels responsive to the player obtaining a threshold number of points during a pre-established time period associated with a subject game level, each subsequent game level increasing in difficulty.

19. The educational tool of claim 18 wherein the game play tool is further configured to interrupt normal game play to display quiz questions randomly or responsive to certain game criteria.

20. The educational tool of claim 18 wherein the game play tool is further configured to interrupt normal game play with bonus play based on pre-established game positions being aligned within said game matrix.

21. The educational tool of claim 18 further comprising a game creation tool including means for a user to perform one or more of the following:
enter a number of game positions to form said game matrix;
enter said text, symbols, colors and/or static or video images to be displayed within said game positions;
enter number of topics and topic types;
enter a number of game levels and associated difficulty;
enter a time period for play of each of said game levels; and
enter points and/or time awarded for specific game results; and
means for randomly incorporating the text, symbols, colors and/or static or video images in the game positions.

22. The educational tool of claim 18 wherein a player is permitted to switch a first game position with a second game position in an effort to align two or more like text, symbols, colors and/or static or video images within said game matrix using a haptic device in communication with said educational tool.
